(19) United States
(12) Patent Application Publication
(10) Pub. No.: US 2025/0240658 A1
(43) Pub. Date: Jul. 24, 2025

(54) CRITERIA-BASED MEASUREMENT REPORTING

(71) Applicant: Nokia Technologies Oy, Espoo (FI)

(72) Inventors: Anna PANTELIDOU, Antony (FR); Dario BEGA, Munich (DE); Cinzia SARTORI, Pullach (DE); Malgorzata TOMALA, Wroclaw (PL)

(21) Appl. No.: 18/701,997

(22) PCT Filed: Oct. 5, 2022
(86) PCT No.: PCT/EP2022/077637

§ 371 Date: Apr. 17, 2024

(30) Foreign Application Priority Data
Oct. 20, 2021 (FI) 20216081

(51) Int. Cl. H04W 24/10; H04L 41/16

(52) U.S. Cl. CPC H04W 24/10; H04L 41/16

(57) ABSTRACT

A method including transmitting a configuration for logging and/or reporting measurement data according to one or more criteria; and receiving a set of measurement data corresponding with the one or more criteria.

### FIELD

The following exemplary embodiments relate to wireless communication.

### BACKGROUND

As resources are limited, it is desirable to optimize the usage of network resources. A terminal device may be utilized to enable better usage of resources.

### SUMMARY

The scope of protection sought for various exemplary embodiments is set out by the independent claims. The exemplary embodiments and features, if any, described in this specification that do not fall under the scope of the independent claims are to be interpreted as examples useful for understanding various exemplary embodiments.

According to an aspect, there is provided an apparatus comprising at least one processor, and at least one memory including computer program code, wherein the at least one memory and the computer program code are configured, with the at least one processor, to cause the apparatus to: transmit a configuration for logging and/or reporting measurement data according to one or more criteria; and receive a set of measurement data corresponding with the one or more criteria.

According to another aspect, there is provided an apparatus comprising means for: transmitting a configuration for logging and/or reporting measurement data according to one or more criteria; and receiving a set of measurement data corresponding with the one or more criteria.

According to another aspect, there is provided a method comprising: transmitting a configuration for logging and/or reporting measurement data according to one or more criteria; and receiving a set of measurement data corresponding with the one or more criteria.

According to another aspect, there is provided a computer program product comprising program instructions which, when run on a computing apparatus, cause the computing apparatus to perform at least the following: transmitting a configuration for logging and/or reporting measurement data according to one or more criteria; and receiving a set of measurement data corresponding with the one or more criteria.

According to another aspect, there is provided a computer program comprising instructions for causing an apparatus to perform at least the following: transmitting a configuration for logging and/or reporting measurement data according to one or more criteria; and receiving a set of measurement data corresponding with the one or more criteria.

According to another aspect, there is provided a computer readable medium comprising program instructions for causing an apparatus to perform at least the following: transmitting a configuration for logging and/or reporting measurement data according to one or more criteria; and receiving a set of measurement data corresponding with the one or more criteria.

According to another aspect, there is provided a non-transitory computer readable medium comprising program instructions for causing an apparatus to perform at least the following: transmitting a configuration for logging and/or reporting measurement data according to one or more criteria; and receiving a set of measurement data corresponding with the one or more criteria.

According to another aspect, there is provided an apparatus comprising at least one processor, and at least one memory including computer program code, wherein the at least one memory and the computer program code are configured, with the at least one processor, to cause the apparatus to: receive a configuration for logging and/or reporting measurement data according to one or more criteria; obtain a set of measurement data corresponding with the one or more criteria; and transmit the set of measurement data corresponding with the one or more criteria.

According to another aspect, there is provided an apparatus comprising means for: receiving a configuration for logging and/or reporting measurement data according to one or more criteria; obtaining a set of measurement data corresponding with the one or more criteria; and transmitting the set of measurement data corresponding with the one or more criteria.

According to another aspect, there is provided a method comprising: receiving a configuration for logging and/or reporting measurement data according to one or more criteria; obtaining a set of measurement data corresponding with the one or more criteria; and transmitting the set of measurement data corresponding with the one or more criteria.

According to another aspect, there is provided a computer program comprising instructions for causing an apparatus to perform at least the following: receiving a configuration for logging and/or reporting measurement data according to one or more criteria; obtaining a set of measurement data corresponding with the one or more criteria; and transmitting the set of measurement data corresponding with the one or more criteria.

According to another aspect, there is provided a computer program product comprising program instructions which, when run on a computing apparatus, cause the computing apparatus to perform at least the following: receiving a configuration for logging and/or reporting measurement data according to one or more criteria; obtaining a set of measurement data corresponding with the one or more criteria; and transmitting the set of measurement data corresponding with the one or more criteria.

According to another aspect, there is provided a computer readable medium comprising program instructions for causing an apparatus to perform at least the following: receiving a configuration for logging and/or reporting measurement data according to one or more criteria; obtaining a set of measurement data corresponding with the one or more criteria; and transmitting the set of measurement data corresponding with the one or more criteria.

According to another aspect, there is provided a non-transitory computer readable medium comprising program instructions for causing an apparatus to perform at least the following: receiving a configuration for logging and/or reporting measurement data according to one or more criteria; obtaining a set of measurement data corresponding with the one or more criteria; and transmitting the set of measurement data corresponding with the one or more criteria.

According to another aspect, there is provided a system comprising at least a first apparatus and a second apparatus. The first apparatus is configured to: transmit, to the second apparatus, a configuration for logging and/or reporting measurement data according to one or more criteria; and receive, from the second apparatus, a set of measurement data corresponding with the one or more criteria. The second apparatus is configured to: receive the configuration from the first apparatus; obtain the set of measurement data corresponding with the one or more criteria; and transmit, to the first apparatus, the set of measurement data corresponding with the one or more criteria.

According to another aspect, there is provided a system comprising at least a first apparatus and a second apparatus. The first apparatus comprises means for: transmitting, to the second apparatus, a configuration for logging and/or reporting measurement data according to one or more criteria; and receiving, from the second apparatus, a set of measurement data corresponding with the one or more criteria. The second apparatus comprises means for: receiving the configuration from the first apparatus; obtaining the set of measurement data corresponding with the one or more criteria; and transmitting, to the first apparatus, the set of measurement data corresponding with the one or more criteria.

### BRIEF DESCRIPTION OF THE DRAWINGS

In the following, various exemplary embodiments will be described in greater detail with reference to the accompanying drawings, in which

FIG. 1 illustrates an exemplary embodiment of a cellular communication network;

FIG. 2 illustrates a data selection functionality according to an exemplary embodiment;

FIGS. 3-4 illustrate signaling diagrams according to some exemplary embodiments;

FIGS. 5-11 illustrate flow charts according to some exemplary embodiments;

FIGS. 12-13 illustrate apparatuses according to some exemplary embodiments.

### DETAILED DESCRIPTION

The following embodiments are exemplifying. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

In the following, different exemplary embodiments will be described using, as an example of an access architecture to which the exemplary embodiments may be applied, a radio access architecture based on long term evolution advanced (LTE Advanced, LTE-A) or new radio (NR, 5G), without restricting the exemplary embodiments to such an architecture, however. It is obvious for a person skilled in the art that the exemplary embodiments may also be applied to other kinds of communications networks having suitable means by adjusting parameters and procedures appropriately. Some examples of other options for suitable systems may be the universal mobile telecommunications system (UMTS) radio access network (UTRAN or E-UTRAN), long term evolution (LTE, substantially the same as E-UTRA), wireless local area network (WLAN or Wi-Fi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

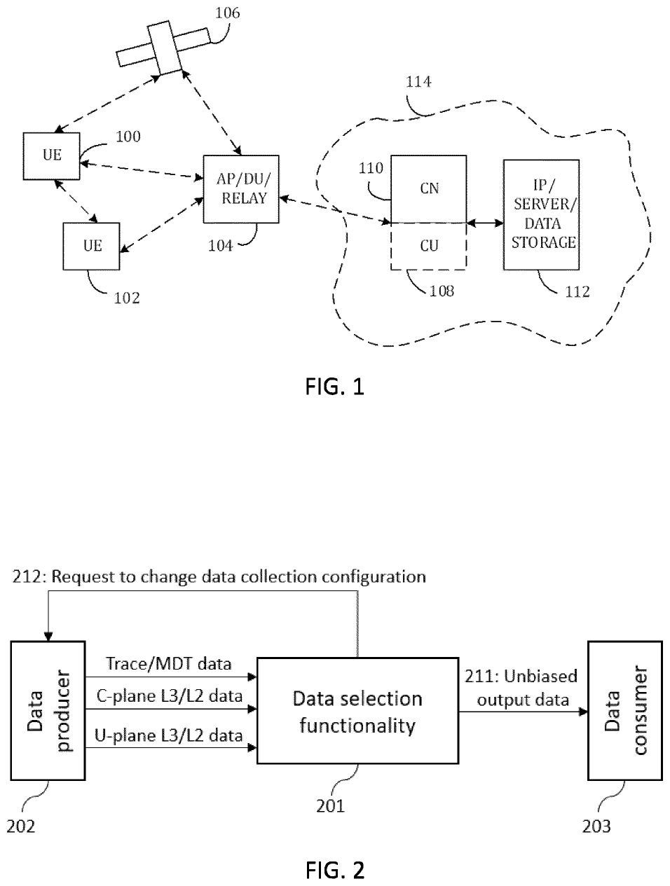

FIG. 1 depicts examples of simplified system architectures showing some elements and functional entities, all being logical units, whose implementation may differ from what is shown. The connections shown in FIG. 1 are logical connections; the actual physical connections may be different. It is apparent to a person skilled in the art that the system may also comprise other functions and structures than those shown in FIG. 1.

The exemplary embodiments are not, however, restricted to the system given as an example but a person skilled in the art may apply the solution to other communication systems provided with necessary properties.

The example of FIG. 1 shows a part of an exemplifying radio access network.

FIG. 1 shows user devices 100 and 102 configured to be in a wireless connection on one or more communication channels in a cell with an access node (such as (e/g)NodeB) 104 providing the cell. The physical link from a user device to a (e/g)NodeB may be called uplink or reverse link and the physical link from the (e/g)NodeB to the user device may be called downlink or forward link. It should be appreciated that (e/g)NodeBs or their functionalities may be implemented by using any node, host, server or access point etc. entity suitable for such a usage.

A communication system may comprise more than one (e/g)NodeB, in which case the (e/g)NodeBs may also be configured to communicate with one another over links, wired or wireless, designed for the purpose. These links may be used for signaling purposes. The (e/g)NodeB may be a computing device configured to control the radio resources of communication system it is coupled to. The (e/g)NodeB may also be referred to as a base station, an access point or any other type of interfacing device including a relay station capable of operating in a wireless environment. The (e/g)NodeB may include or be coupled to transceivers. From the transceivers of the (e/g)NodeB, a connection may be provided to an antenna unit that establishes bi-directional radio links to user devices. The antenna unit may comprise a plurality of antennas or antenna elements. The (e/g)NodeB may further be connected to core network 110 (CN or next generation core NGC). Depending on the system, the counterpart on the CN side may be a serving gateway (S-GW, routing and forwarding user data packets), packet data network gateway (P-GW), for providing connectivity of user devices (UEs) to external packet data networks, mobility management entity (MME), or location management function (LMF), etc.

The user device (also called UE, user equipment, user terminal, terminal device, etc.) illustrates one type of an apparatus to which resources on the air interface may be allocated and assigned, and thus any feature described herein with a user device may be implemented with a corresponding apparatus, such as a relay node. An example of such a relay node may be a layer 3 relay (self-backhauling relay) towards the base station. The self-backhauling relay node may also be called an integrated access and backhaul (IAB) node. The IAB node may comprise two logical parts: a mobile termination (MT) part, which takes care of the backhaul link(s) (i.e., link(s) between IAB node and a donor node, also known as a parent node) and a distributed unit (DU) part, which takes care of the access link(s), i.e., child link(s) between the IAB node and UE(s) and/or between the IAB node and other IAB nodes (multi-hop scenario).

The user device may refer to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a user device may also be a nearly exclusive uplink only device, of which an example may be a camera or video camera loading images or video clips to a network. A user device may also be a device having capability to operate in Internet of Things (IoT) network which is a scenario in which objects may be provided with the ability to transfer data over a network without requiring human-to-human or human-to-computer interaction. The user device may also utilize cloud. In some applications, a user device may comprise a small portable device with radio parts (such as a watch, earphones or eyeglasses) and the computation may be carried out in the cloud. The user device (or in some exemplary embodiments a layer 3 relay node) may be configured to perform one or more of user equipment functionalities. The user device may also be called a subscriber unit, mobile station, remote terminal, access terminal, user terminal, terminal device, or user equipment (UE) just to mention a few names or apparatuses.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question may have inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications may support a wide range of use cases and related applications including video streaming, augmented reality, different ways of data sharing and various forms of machine type applications (such as (massive) machine-type communications (mMTC), including vehicular safety, different sensors and real-time control. 5G may be expected to have multiple radio interfaces, namely below 6 GHz, cmWave and mmWave, and also being integrable with existing legacy radio access technologies, such as the LTE. Integration with the LTE may be implemented, at least in the early phase, as a system, where macro coverage may be provided by the LTE, and 5G radio interface access may come from small cells by aggregation to the LTE. In other words, 5G may support both inter-RAT operability (such as LTE-5G) and inter-RI operability (inter-radio interface operability, such as below 6 GHz-cmWave, below 6 GHz-cmWave-mmWave). One of the concepts considered to be used in 5G networks may be network slicing in which multiple independent and dedicated virtual sub-networks (network instances) may be created within the substantially same infrastructure to run services that have different requirements on latency, reliability, throughput and mobility.

The current architecture in LTE networks may be fully distributed in the radio and fully centralized in the core network. The low latency applications and services in 5G may need to bring the content close to the radio which leads to local break out and multi-access edge computing (MEC). 5G may enable analytics and knowledge generation to occur at the source of the data. This approach may need leveraging resources that may not be continuously connected to a network such as laptops, smartphones, tablets and sensors. MEC may provide a distributed computing environment for application and service hosting. It may also have the ability to store and process content in close proximity to cellular subscribers for faster response time. Edge computing may cover a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system may also be able to communicate with other networks, such as a public switched telephone network or the Internet 112, or utilize services provided by them. The communication network may also be able to support the usage of cloud services, for example at least part of core network operations may be carried out as a cloud service (this is depicted in FIG. 1 by “cloud” 114). The communication system may also comprise a central control entity, or a like, providing facilities for networks of different operators to cooperate for example in spectrum sharing.

Edge cloud may be brought into radio access network (RAN) by utilizing network function virtualization (NFV) and software defined networking (SDN). Using edge cloud may mean access node operations to be carried out, at least partly, in a server, host or node operationally coupled to a remote radio head (RRH) or a radio unit (RU), or a base station comprising radio parts. It may also be possible that node operations will be distributed among a plurality of servers, nodes or hosts. Carrying out the RAN real-time functions at the RAN side (in a distributed unit, DU 104) and non-real time functions in a centralized manner (in a central unit, CU 108) may be enabled for example by application of cloudRAN architecture.

It should also be understood that the distribution of labour between core network operations and base station operations may differ from that of the LTE or even be non-existent. Some other technology advancements that may be used may be Big Data and all-IP, which may change the way networks are being constructed and managed. 5G (or new radio, NR) networks may be designed to support multiple hierarchies, where MEC servers may be placed between the core and the base station or nodeB (gNB). It should be appreciated that MEC may be applied in 4G networks as well.

5G may also utilize satellite communication to enhance or complement the coverage of 5G service, for example by providing backhauling. Possible use cases may be providing service continuity for machine-to-machine (M2M) or Internet of Things (IoT) devices or for passengers on board of vehicles, or ensuring service availability for critical communications, and future railway/maritime/aeronautical communications. Satellite communication may utilize geostationary earth orbit (GEO) satellite systems, but also low earth orbit (LEO) satellite systems, in particular mega-constellations (systems in which hundreds of (nano)satellites are deployed). At least one satellite 106 in the mega-constellation may cover several satellite-enabled network entities that create on-ground cells. The on-ground cells may be created through an on-ground relay node 104 or by a gNB located on-ground or in a satellite.

It is obvious for a person skilled in the art that the depicted system is only an example of a part of a radio access system and in practice, the system may comprise a plurality of (e/g)NodeBs, the user device may have an access to a plurality of radio cells and the system may also comprise other apparatuses, such as physical layer relay nodes or other network elements, etc. At least one of the (e/g)NodeBs or may be a Home(e/g)nodeB.

Furthermore, the (e/g)nodeB or base station may also be split into: a radio unit (RU) comprising a radio transceiver (TRX), i.e., a transmitter (Tx) and a receiver (Rx); one or more distributed units (DUs) that may be used for the so-called Layer 1 (L1) processing and real-time Layer 2 (L2) processing; and a central unit (CU) or a centralized unit that may be used for non-real-time L2 and Layer 3 (L3) processing. The CU may be connected to the one or more DUs for example by using an F1 interface. Such a split may enable the centralization of CUs relative to the cell sites and DUs, whereas DUs may be more distributed and may even remain at cell sites. The CU and DU together may also be referred to as baseband or a baseband unit (BBU). The CU and DU may also be comprised in a radio access point (RAP).

The CU may be defined as a logical node hosting higher layer protocols, such as radio resource control (RRC), service data adaptation protocol (SDAP) and/or packet data convergence protocol (PDCP), of the (e/g)nodeB or base station. The DU may be defined as a logical node hosting radio link control (RLC), medium access control (MAC) and/or physical (PHY) layers of the (e/g)nodeB or base station. The operation of the DU may be at least partly controlled by the CU. The CU may comprise a control plane (CU-CP), which may be defined as a logical node hosting the RRC and the control plane part of the PDCP protocol of the CU for the (e/g)nodeB or base station. The CU may further comprise a user plane (CU-UP), which may be defined as a logical node hosting the user plane part of the PDCP protocol and the SDAP protocol of the CU for the (e/g)nodeB or base station.

Cloud computing platforms may also be used to run the CU and/or DU. The CU may run in a cloud computing platform, which may be referred to as a virtualized CU (vCU). In addition to the vCU, there may also be a virtualized DU (vDU) running in a cloud computing platform. Furthermore, there may also be a combination, where the DU may use so-called bare metal solutions, for example application-specific integrated circuit (ASIC) or customer-specific standard product (CSSP) system-on-a-chip (SoC) solutions. It should also be understood that the distribution of labour between the above-mentioned base station units, or different core network operations and base station operations, may differ.

Additionally, in a geographical area of a radio communication system, a plurality of different kinds of radio cells as well as a plurality of radio cells may be provided. Radio cells may be macro cells (or umbrella cells) which may be large cells having a diameter of up to tens of kilometers, or smaller cells such as micro-, femto- or picocells. The (e/g)NodeBs of FIG. 1 may provide any kind of these cells. A cellular radio system may be implemented as a multilayer network including several kinds of cells. In multilayer networks, one access node may provide one kind of a cell or cells, and thus a plurality of (e/g)NodeBs may be needed to provide such a network structure.

For fulfilling the need for improving the deployment and performance of communication systems, the concept of “plug-and-play” (e/g)NodeBs may be introduced. A network which may be able to use “plug-and-play” (e/g)NodeBs, may include, in addition to Home (e/g)NodeBs (H(e/g)nodeBs), a home node B gateway, or HNB-GW (not shown in FIG. 1). A HNB Gateway (HNB-GW), which may be installed within an operator's network, may aggregate traffic from a large number of HNBs back to a core network.

Radio frequency (RF) drive testing is a technique for measuring and assessing the coverage, capacity and quality of service (QoS) of a radio network. The technique may involve using a motor vehicle comprising air interface measurement equipment that can detect and record a wide variety of the physical and virtual parameters of mobile cellular service in a given geographical area. By measuring what a wireless network subscriber would experience in a specific area, mobile operators can make directed changes to their networks that provide better coverage and service to their users.

Minimization of drive testing (MDT) is a standardized 3GPP feature that allows a mobile operator to collect measurement data directly from commercial UEs (e.g., customer devices) for performance optimization of the network. Thus, MDT may reduce the need for drive testing with dedicated measurement equipment, as well as help to obtain measurement information from areas (e.g., indoor or pedestrian areas) that are not accessible by the vehicle used for the drive testing. MDT involves regular users of cellular network and makes usage of their data that are collected anyway (e.g., for mobility purposes). The measurement data collected from the UEs via MDT may comprise, for example, global positioning system (GPS) location information, reference signal received power (RSRP) measurements, signal-to-interference-plus-noise ratio (SINR) measurements, and/or reference signal received quality (RSRQ) measurements.

MDT data can be gathered in two different modes: immediate MDT and logged MDT.

Immediate MDT is a procedure involving measurements performed by a UE in connected state. The UE is configured by the network while in connected state to generate a real-time report of radio measurements immediately after performing them. For immediate MDT, RAN measurements and UE measurements can be configured. The UE provides the network with detailed location information, if available. This location information may comprise global navigation satellite system (GNSS) information, if the UE has its GNSS switched-on and if it is willing to provide such information to the network. The UE may also provide the network with neighbour cell measurement information that can help to determine the UE's location. In addition, the cell identity of the serving cell as a coarse technique of providing UE location to the network is assumed to be known.

Logged MDT is a procedure, in which a UE is configured by the network with a logged measurement configuration while in Connected State but the actual logging of measurements occurs when the UE is in idle or inactive states. Once the UE has a log available, it can indicate measurement availability to the network through an RRC message and the network can obtain the logged reports through the UEInformationRequest/Response procedure. Herein logging means that the UE stores the measurements within its internal memory.

Management-based MDT techniques allow collection of measurements from multiple UEs for example in a certain area (e.g., based on cell IDs, tracking areas, routing areas, or location areas). Management-based MDT can be either logged MDT or immediate MDT.

Signaling-based MDT techniques instruct a specific UE to provide measurements (i.e., MDT data is collected from a specific UE addressed by its IMSI or IMEI, for example). Signaling-based MDT can be either logged MDT or immediate MDT.

Both management-based MDT and signaling-based MDT may use trace functionality to configure and report data collection.

Machine learning (ML) and/or other artificial intelligence (AI) algorithms may be applied in various areas of a communication system, for example for steering data traffic or detecting changes in the system. AI/ML may also be used in MIMO applications such as beam management, predictable mobility, channel state information (CSI) acquisition, as well as in other physical (PHY) domains such as positioning, reference signals, and/or resource allocation. The introduction of network intelligence via AI/ML introduces different needs on the data collection. This is because ML may involve a massive amount of data to be exchanged for training, and the data collection needs to be done in a systematic way. Currently, when data is requested, the data may be collected by leveraging existing mechanisms and is subsequently formatted to be utilized by the AI/ML model.

Machine learning may considerably increase the amount of data that needs to be collected for training purposes. The training of an AI/ML model may take place at a central entity that collects the information from different entities, where measurements are available. As an example, when the training takes place at the operations, administration and maintenance (OAM) function or at a CU, then the OAM function or CU may request data from UEs for training. Subsequently, those UEs may perform the requested measurements (frequently enough) and report them to the network. This reporting may consume a large amount of network resources and decrease the spectral efficiency.

As one option, in order to reduce the amount of reporting, a UE may train an ML model locally available at the UE (instead of training the model at the central entity). In this case, the trained ML model may be retrieved by the network after the training at the UE is completed.

However, some UEs may not be capable of training an ML model, in which case the training may need to be performed at the network side. This may also be the case for an ML algorithm that uses a centralized collection of a large number of UE measurements for performing the training.

On the other hand, the data collection for an AI/ML model may be different than other existing data collection mechanisms, since it may involve a very careful analysis of the data utilized for training the model. This is because the analytics produced by utilizing an AI/ML model reflect the statistics of the input data used for training the model. If the training data contains biases, those biases may be reflected in the outputs of the trained model. Data bias in machine learning is a type of error, in which certain elements of the dataset are more heavily weighted and/or represented than others. A biased dataset may not accurately represent the model's use case, thus resulting in skewed outcomes, low accuracy levels, and analytical errors. Furthermore, if the training data shows gaps (e.g., data is missing for a certain time interval), this may also be reflected in the outputs of the model.

Existing management-based MDT techniques allow the management system to obtain measurements from UEs based on an area, for example via a list of cells described by the area scope or by the MDT public land mobile network (PLMN) list. However, these may be rather static and there are no data selection conditions, or criteria, when data is needed for training an AI/ML model. The UEs connected to a certain area may report the configured measurements without any other selection criteria. Furthermore, the network may not support controlling the measurement collection dynamically, by increasing or decreasing the rate or amount of measurements, based on the received measurements. In this way, without any control on the data collected, there may currently be no protection against AI/ML bias that may lead to generating incorrect analytics.

The information made available for training an AI/ML model may become unsuitable, as well as generate signaling overhead and significant load to network interfaces. Thus, there is a challenge in how to adapt the data collection from UEs to an AI/ML-based framework.

Extending the MDT framework and/or the RRC measurement configuration for provisioning of measurements by UEs in a more focused and targeted way may be beneficial also for general measurement provision in addition to ML training. By enabling the network to obtain measurements from UEs in a more selective manner, the amount of collected measurements may be reduced, thus saving UE and network resources as well as reducing power consumption.

FIG. 2 illustrates a data selection functionality (DSf) 201 according to an exemplary embodiment. The DSf 201 may be used for adjusting the collection of measurements according to one or more criteria (i.e., conditions). The DSf 201 may reside in an ML-based producer-consumer framework.

For example, the DSf 201 may be comprised in an OAM function or in a non-real-time RAN intelligent controller (RIC). Alternatively, the DSf 201 may be comprised in a gNB or in a real-time RIC, or in a CU or DU in case of split architecture. Alternatively, the DSf 201 may be comprised in a UE.

An objective of the DSf 201 may be to reduce the amount of measurement data reported by UEs and unnecessarily collected by the network, and to adjust the collected measurements to solve potential bias or gap or any other error type that may affect a training dataset for a specific ML model.

The DSf 201 may receive measurement data from one or more data producers 202. Herein a data producer may refer to, for example, a CU, a DU (in case of disaggregated RAN), a gNB (in case of monolithic RAN), or a UE. The measurement data received from the one or more data producers 202 may comprise, for example, trace/MDT data, control plane (C-plane) L3/L2 data, and/or user plane (U-plane) L3/L2 data.

The DSf 201 maybe capable of identifying duplicated data, unbalanced data, biased data, outliers, etc., from the received measurement data. Based on its logic, the DSf may provide a proper set of consistent data 211 to one or more data consumers 203. In other words, the DSf 201 may remove at least bias data and/or duplicate data from the received measurement data, and provide unbiased data 211 (or at least with reduced bias) to the one or more data consumers 203. The removal of bias data and/or duplicate data may also be referred to as data cleaning, such as detecting and fixing corrupted and/or inaccurate data records, dealing with missing data or values, etc. For example, if the DSf detects missing data or values, then the DSf may request additional data or values from the one or more data producers 202.

The one or more data consumers 203 may comprise, for example, an ML training entity and/or an entity providing analytics, such as a network data analytics function (NWDAF) and/or a management data analytics function (MDAF). The ML training entity refers to an entity responsible for training one or more machine learning models. In other words, the ML training entity may be configured to train one or more machine learning models based on the data 211 provided from the DSf 201.

The DSf 201 may transmit a request 212 to the one or more data producers 202 (e.g., CU), for example in an MDT configuration message, to generate or change the data collection configuration associated with one or more UEs. Alternatively, the DSf 201 may transmit the request 212 directly to the one or more UEs, for example in an RRC configuration message, instead of instructing the one or more UEs via the data producer (e.g., CU). With the request 212, the DSf 201 may indicate a data collection configuration to control the type and/or amount of measurement data provided by the one or more UEs. Thus, the data collection configuration may target the specific data that is needed to balance the training data set that is collected or under collection. The measurement data may be provided to the DSf 201 directly from the one or more UEs, or indirectly via a CU, for example.

In one example, the configuration comprised in the request 212 may instruct the one or more UEs to log measurement data according to one or more criteria defined by the DSf in the configuration. In case the UE measurements are requested by CU-CP, the DSf request 212 may result in a new enhanced UE RRC configuration, wherein data selection may be provided either per measurement such that a given measurement has its own data selection criteria, or per group of measurements requested from a UE.

In another example, the configuration comprised in the request 212 may instruct the one or more UEs to report measurement data according to the one or more criteria defined by the DSf in the configuration.

The configuration may indicate to apply the one or more criteria, when operating at the data producer side and/or at the measurement (UE) side. In one example, the configuration may indicate an “and” operation to collect customized data according to multiple criteria, for example as a function f(A1,A2)={A1} AND {A2}, where A1 denotes a first criterion and A2 denotes a second criterion for data selection. It should be noted that the function f( ) may be applicable to an arbitrary number of criteria A1, A2, . . . Ax, wherein x may be any integer above zero.

Alternatively, the function f( ) may correspond to a union of criteria. For example f(A1,A2)={A1}OR {A2}, where A1 denotes the first criterion and A2 the second criterion. Similarly as before, the function f( ) may be applicable to an arbitrary number of criteria AI, A2, . . . Ax, wherein x may be any integer above zero.

As a non-limiting example, the one or more criteria may be represented by a function f(area, radio signal level), wherein the area criterion may be represented by the base station's cell property (Cell Global Identifier, Physical Cell ID or frequency), and the radio signal level criterion may be represented by a threshold or range of RSRP, RSRQ and/or SINR, representing signal level value(s), which would classify the measured radio signal quantity to be applicable, if the measured radio signal quantity is within the range. In other words, in this example, the configuration may instruct the one or more UEs to log and/or report measurement data, if the area criterion and the radio signal level criterion are fulfilled.

The configuration may further indicate different options of how to handle measurement data that does not fulfil (satisfy) the one or more criteria. For example, the DSf may provide a configuration that instructs the UE to tag the measurement data that fulfills the one or more criteria and to report both tagged and untagged measurement data to the network.

Alternatively, the DSf may provide a configuration that instructs the UE to tag a first set of measurement data that fulfils the one or more criteria with a specific label (referred to as a first label), and to tag a second set of measurement data that does not fulfil the one or more criteria with a different label (referred to as a second label). Thus, the first label may indicate that the one or more criteria are fulfilled by the associated first set of measurement data, and the second label may indicate that the one or more criteria are not fulfilled by the associated second set of measurement data. The UE may log and/or report both the first set of measurement data associated with the first label and the second set of measurement data associated with the second label. In this way, the second set of measurement data that does not fulfil the one or more criteria may still be used by the network for example for MDT logging and reporting or for network troubleshooting, even though the second set of measurement data is not used for ML training. On the other hand, the UE may use tagging to indicate the first set of measurement data that fulfilled the one or more criteria and that can be used for the ML training purpose. Tagging a set of measurement data allows the network to handle those measurements differently. Herein a label may also be referred to as a tag.

Thus, the DSf 201 may select, based on the tagging, the first set of measurement data that fulfilled the one or more criteria in order to include the first set of measurement data in the unbiased data 211 that is provided to the one or more data consumers 203. In addition, the DSf 201 may exclude the second set of measurement data that did not fulfill the one or more criteria from the unbiased data 211. Herein the terms “first set of measurement data” and “second set of measurement data” are used to distinguish the datasets, and they do not necessarily mean a specific order of the datasets.

Alternatively, some of the measurements may be discarded for example in case data collection is requested specifically for a certain use case and for training an ML model, or if specific data that meets the one or more criteria is needed (this may be beneficial for example in case of high network load). Thus, the DSf may instruct the UE to log and/or report the tagged measurement data (e.g., measurement data that meets the criteria), and to discard the untagged measurement data (e.g., measurement data that does not meet the criteria). Alternatively, the DSf may instruct the UE to tag and/or report the untagged measurement data (e.g., measurement data that does not meet the criteria), and to discard the tagged measurement data (e.g., measurement data that meets the criteria). The discarding may refer to deleting or ignoring that particular measurement data.

Which option to use (e.g., discard or tag) may be indicated in the configuration set by the network (e.g., in the MDT configuration or RRC configuration).

The mechanism may be further enhanced by instructing the UE to report tagged measurement data with a different periodicity (e.g., more frequently or less frequently) than untagged measurement data. Alternatively or additionally, the UE may be instructed to report tagged measurement data by using a different signaling radio bearer (SRB) or different radio resources compared to those used for untagged measurement data. Alternatively or additionally, the UE may be instructed to report the tagged measurement data in a different type of message or report than the one used for untagged measurement data. This can be done by enhancing the trace/MDT configuration to instruct the UE on how to do the reporting, depending on how its measurements compare to the one or more criteria.

As an example, the DSf may be interested in receiving measurement data from a specific network slice (e.g., slice A) or a slice group (e.g., slice group 1) for the purpose of training an ML model. In this case, the configuration may indicate, for example, a function f(A1)={measurements taken in slice A}, i.e., the one or more criteria are fulfilled by measurement data associated with slice A. Consequently, the UE may be configured to report measurement data from a plurality of network slices but to tag the measurement data associated with the slice of interest (e.g., slice A or slice group 1) with a specific label. Alternatively, the UE may be configured to report just the tagged measurement data (e.g., measurements from slice A), and to discard any other measurement data coming from other network slices.

Similarly, the network may request the UE to report measurement data needed for training an ML model (e.g., measurements under slice A) more frequently and/or by using a higher-priority SRB, or even by using a separate report.

In another example, the configuration comprised in the request 212 may enable the network to group UEs according to the one or more criteria indicated in the configuration. The DSf 201 and related signaling (trace/MDT/RRC configuration) may provide the network with additional means for grouping UEs, wherein logging and/or reporting of measurement data is limited to those UEs that fulfil the one or more criteria. In other words, the one or more criteria may be used by the one or more data producers 202 to down-select the UEs that log or report measurement data for example in management-based logged MDT or in immediate MDT. For example, a given UE may be determined to fulfil the one or more criteria for logging and/or reporting of measurement data, if the UE is associated with a specific network slice, if the UE is associated with a specific group of network slices, and/or if the UE supports certain service(s). This grouping of UEs may be area-independent, which means that the grouping is not done based on an area where a given UE is located.

In management-based logged MDT, measurement data from UEs that fulfil the one or more criteria may be logged, while measurement data from other UEs that do not fulfil the one or more criteria may be discarded.

In management-based immediate MDT, measurement data from UEs that fulfil the one or more criteria may be reported, while measurement data from other UEs that do not fulfil the one or more criteria may be discarded.

In one deployment option, the DSf 201 may be provided as a standalone function queried by the one or more data consumers 203. In another deployment option, the DSf may be comprised in an existing network function, for example in a NWDAF for the core network, in an MDAF for OAM, or in any RAN network function (e.g., CU or DU) for the RAN. The DSf 201 may be centralized (e.g., by residing in an OAM function), or the DSf 201 may be decentralized (e.g., by residing in RAN).

As one use case example, the measurement data collected via the DSf may be used for steering data traffic. In order to train an ML model to predict the load for different types of data traffic, the model needs to be trained with enough data (balanced dataset) from a given type of data traffic. Therefore, the DSf may analyze the training data to detect an underrepresented type of traffic. If an underrepresented type of traffic is detected, then data collection for this specific type of traffic may be triggered. The DSf may use slicing information, for example slice service type (sst) and/or sst slice differentiator (sst-sd), over which data is requested. If a certain network slice is underrepresented in the received UE measurements, then the network may perform a reconfiguration, under the substantially same Trace/MDT Activation, to request more measurements for this particular network slice. Examples of such functionalities are presented in the following.

In a first example, the UE may be requested to obtain measurement data from a certain network slice or group of network slices.

In a second example, the UE may be requested to obtain measurement data from a specific sequence of network slices, i.e., when a specific network slice (slice x) is followed by another specific network slice (slice y). In other words, the UE may be configured to log and/or report measurement data, if at any point in time it is served by slice x and then by slice y. For example, a UE that is served by slice x may move to a cell where slice x is not supported, and thus the call or data session may be transferred to slice y. The network slices may be identified, for example, by slice ID, single network slice selection assistance information (S-NSSAI), and/or slice group ID.

In a third example, the UE may be requested to obtain measurement data for one or more specific services, such as multicast and broadcast services (MBS), multimedia telephony service for IMS (MTSI), and/or virtual reality (VR) services. IMS is an abbreviation for internet protocol (IP) multimedia subsystem.

In a fourth example, the UE may be requested to obtain at least a first number (num_x) of measurements from a first network slice (slice x), and a second number (num_y) of measurements from a second network slice (slice y). This may correspond to a function f(A1, A2)=A1 AND A2, with A1={at least num_x measurements from slice x} and A2={at least num_y measurements from slice y}. If slice x has less than num_x measurements, then the UE may be configured to not report the measurements obtained for slice x.

In a fifth example, the UE may be requested to obtain at least a first number (num_x) of measurements from a first network slice (slice x), and a second number (num_y) of measurements from a second network slice (slice y). When the UE sends less than num_x measurements for slice x, then the UE may be reconfigured under the substantially same Trace/MDT Activation to report more measurements for slice x (but not for slice y).

Herein the terms “first network slice” and “second network slice” are used to distinguish the slices, and they do not necessarily mean a specific order of the slices.

As another use case example, the DSf may be used to detect abrupt changes in the communication system. The UE may be indicated to obtain and report the corresponding measurement data, if a difference between two consecutive signal level values is larger than or equal to a first threshold value. In this case, an example of function f( ) may be f(A1)={absolute value of signal level value 2 minus signal level value 1 is greater than threshold1}, or more generally as f(A1)={absolute value of measurement value 2 minus measurement value 1 is greater than threshold1}. The signal level values (or measurement data in general) as well as the threshold evaluating the reporting condition may be indicated in the configuration given to the UE. For example, if a difference between a measured RSRP, SINR or RSRQ value and a previously measured RSRP, SINR, or RSRQ value is larger than or equal to the first threshold value, then the UE may report the corresponding measurement data.

In another example, the UE may be indicated to log and/or report the corresponding measurement data, if a measured signal level value exceeds a second threshold value. The measured signal level value may refer to, for example, an RSRP, SINR, or RSRQ value. In this case, an example of function f( ) may be f(A1)={signal level value greater than threshold2′}, which means that the UE is configured to log and/or report measurement data satisfying the function f(A1). The reported signal level values (measurement data) may comprise the RSRP, SINR and/or RSRQ value(s) measured by the UE. Similar criteria can be defined, if the reported signal level value is less than a threshold value. Otherwise, the UE does not report the measurement data in this example.

Alternatively, the UE may be indicated to obtain and report the corresponding measurement data, if the performance at the UE decreases by more than a third threshold (reference) value. For example, if a delay, a packet loss rate, and/or energy consumption at the UE increases by more than the third threshold value, or the UE throughput decreases by more than the third threshold value, then the UE may report the corresponding measurement data. Otherwise, the UE may not report the measurement data. For example, the function f( ) may be defined as f(A1)={performance decreases by more than threshold3}, wherein the performance may be measured in terms of a UE throughput value, an energy consumption metric (e.g., as a number of watts for a given operation or in joules), a packet loss rate, to name a few.

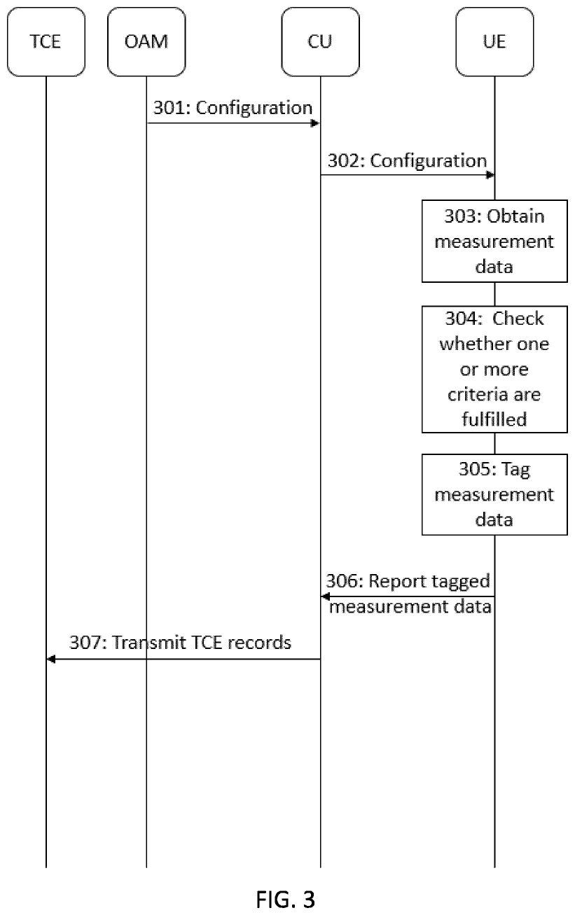

FIG. 3 illustrates a signaling diagram according to an exemplary embodiment. Referring to FIG. 3, a first network element (e.g., an OAM function) hosting a DSf transmits 301 a trace activation message to a second network element (e.g., a gNB or a CU). The trace activation message may comprise a configuration for logging and/or reporting measurement data according to one or more criteria. The configuration may indicate at least to tag the measurement data that fulfils the one or more criteria.

The second network element transmits 302 an MDT activation message comprising the configuration to a UE. The UE applies the configuration.

The UE obtains 303 measurement data, and checks 304 whether the one or more measurement data fulfils the one or more criteria. If the measurement data fulfils the one or more criteria, then the UE tags 305 the measurement data with a label indicating that the one or more criteria are fulfilled. If the measurement data does not fulfil the one or more criteria, then the UE may discard the measurement data or tag the measurement data with a different label to indicate that the one or more criteria are not fulfilled.

The UE transmits 306 an MDT report to the second network element, wherein the MDT report may comprise at least the measurement data that fulfilled the one or more criteria. In one option, the associated label may be included together with the measurement data that fulfilled the one or more criteria. Alternatively or additionally, the MDT report may comprise the measurement data that did not fulfil the one or more criteria, as well as the associated label.

Upon receiving the MDT report, the second network element transmits 307 one or more trace collection entity (TCE) records to a TCE. The one or more TCE records are reports that may be generated based on OAM request. The one or more TCE records may comprise the measurement data reported by the UE.

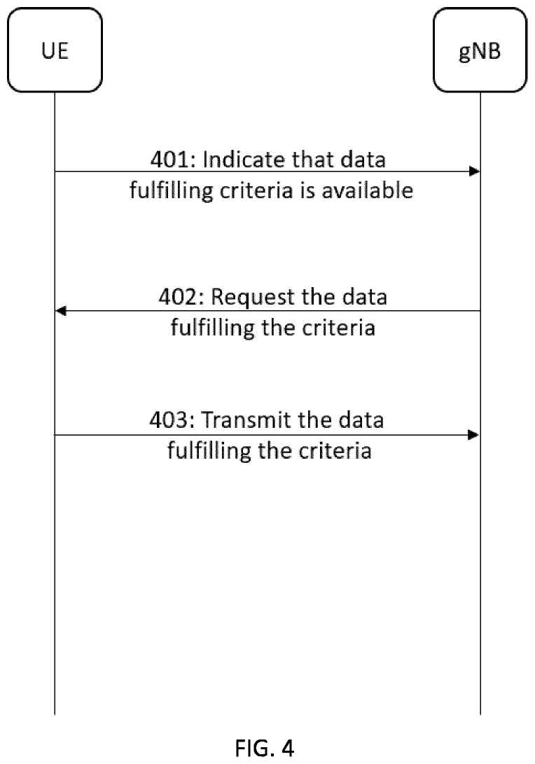

FIG. 4 illustrates a signaling diagram according to another exemplary embodiment. Referring to FIG. 4, a UE indicates 401 to a network element (such as a gNB, a CU, or a DSf) that measurement data fulfilling one or more criteria is available. The indication 401 may be comprised, for example, in an RRCSetupComplete message, in an RRCReconfigurationComplete message, in an RRCReestablishmentComplete message, or in an RRCResumeComplete message.

In response to receiving the indication, the network element transmits 402 a request to the UE to provide the measurement data that fulfils the one or more criteria to the network element. The retrieval of the measurement data may be done over different SRBs depending on the data priority of the data fulfilling the one or more criteria versus not fulfilling the one or more criteria, and thus the network element may indicate a specific SRB to the UE for providing different measurement data to the network element. For example, data that is used for training an offline ML algorithm may be assigned a lower priority than data needed for monitoring network performance.

In response to receiving the request, the UE transmits 403 the measurement data that fulfils the one or more criteria to the network element for example over the SRB indicated by the network element.

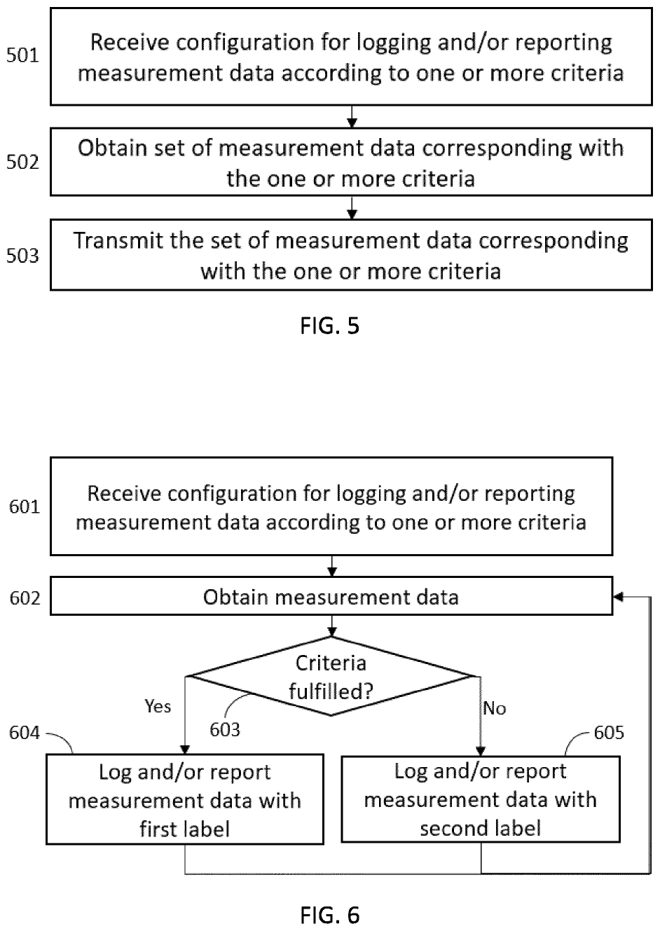

FIG. 5 illustrates a flow chart according to an exemplary embodiment. The steps illustrated in FIG. 5 may be performed by an apparatus such as, or comprised in, a terminal device (UE).

Referring to FIG. 5, a message is received 501 from a network element of a wireless communication network (e.g., from a base station, CU, or DSf), wherein the message indicates a configuration for logging and/or reporting measurement data according to one or more criteria. A set of measurement data corresponding with the one or more criteria is obtained 502, for example by performing radio measurements, such as RSRP, RSRQ, and/or SINR measurements, on one or more received radio signals. The set of measurement data corresponding with the one or more criteria is transmitted 503 to the network element (or to a different network element).

FIG. 6 illustrates a flow chart according to another exemplary embodiment. The steps illustrated in FIG. 6 may be performed by an apparatus such as, or comprised in, a terminal device (UE). In this exemplary embodiment, the UE may be instructed to log and/or report measurement data with a label or cause to indicate whether or not the measurement data fulfils one or more criteria.

Referring to FIG. 6, a message is received 601 from a network element of a wireless communication network (e.g., from a base station, CU, or DSf), wherein the message indicates a configuration for logging and/or reporting measurement data according to one or more criteria. For example, the configuration may instruct the UE to tag measurement data that fulfils the one or more criteria with a specific label (referred to as a first label), and to tag measurement data that does not fulfil the one or more criteria with a different label (referred to as a second label).

Measurement data is obtained 602. If the measurement data fulfils the one or more criteria (603: yes), then the measurement data is tagged with the first label to indicate that the measurement data fulfilled the one or more criteria. The measurement data tagged with the first label is logged and/or reported 604 to the network element. The process may be iterative such that it returns to step 602 after step 604.

If the measurement data does not fulfil the one or more criteria (603: no), then the measurement data is tagged with the second label to indicate that the measurement data did not fulfil the one or more criteria. The measurement data tagged with the second label is logged and/or reported 605 to the network element. The process may be iterative such that it returns to step 602 after step 605.

For immediate MDT or RRC configuration, the UE may tag and report the measurement data. The applied one or more criteria may also be reported by the UE together with an indication indicating whether or not the one or more criteria were fulfilled.

For logged MDT, the UE may tag and log the measurement data. In other words, the report message may be stored in a log file and transmitted at a later point in time instead of being immediately reported as in immediate MDT.

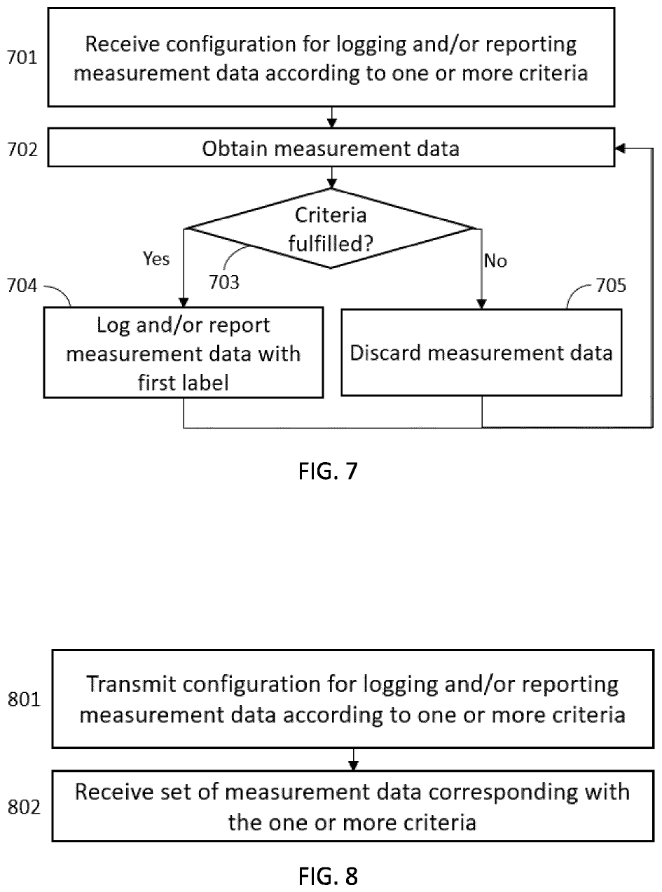

FIG. 7 illustrates a flow chart according to another exemplary embodiment. The steps illustrated in FIG. 7 may be performed by an apparatus such as, or comprised in, a terminal device (UE).

Referring to FIG. 7, a message is received 701 from a network element of a wireless communication network (e.g., from a base station, CU, or DSf), wherein the message indicates a configuration for logging and/or reporting measurement data according to one or more criteria. For example, the configuration may instruct the UE to tag the measurement data that fulfils the one or more criteria with a specific label (referred to as a first label), and to discard the measurement data that does not fulfil the one or more criteria.

Measurement data is obtained 702. In one option, if the measurement data fulfils the one or more criteria (703: yes), then the measurement data is tagged with the first label to indicate that the measurement data fulfilled the one or more criteria. The measurement data tagged with the first label is logged and/or reported 704 to the network element. The process may be iterative such that it returns to step 702 after step 704.

If the measurement data does not fulfil the one or more criteria (703: no), then the measurement data is discarded 705 (i.e., neither logged nor reported). In this case, the UE does not provide the measurement data to the network element, even if the UE belongs to an MDT PLMN list. The process may be iterative such that it returns to step 702 after step 705.

It should be noted that in the example of FIG. 7, tagging of the measurement data that fulfils the one or more criteria is optional, since the measurement data that does not meet the one or more criteria is discarded. Thus, the logged and/or reported measurement data comprises the measurement data that fulfils the one or more criteria, but not the measurement data that does not fulfil the one or more criteria.

For immediate MDT or RRC (re)configuration, the UE may report the measurement data that fulfils the one or more criteria, and discard the measurement data that does not fulfil the one or more criteria. For example, the UE may apply the one or more criteria to the MeasurementReport message comprising MeasResults, and produce (i.e., generate) measurements fulfilling the one or more criteria. The outcome of the applied criteria may be tagged measurements (with a tag or label), for example a DSf parameter such as DSf purpose, different interval, or other tag specific to the DSf request. The generated measurements may be signaled by the UE via an updated MeasurementReport message or a separate or new RRC message.

For logged MDT, the UE may log the measurement data that fulfils the one or more criteria, and discard the measurement data that does not fulfil the one or more criteria. In other words, the log with the measurement data that fulfils the one or more criteria may be stored in a log file and transmitted at a later point in time instead of being immediately reported as in immediate MDT. In this case, the UE may apply the one or more criteria to the UEInformationResponse message comprising LogMeasReport, and produce (i.e., generate) the logged measurement data that fulfils the DSf criteria, while excluding the measurements that did not fulfil the DSf criteria. The generated report may be an updated UEInformationResponse message or a separate or new RRC report.

FIG. 8 illustrates a flow chart according to an exemplary embodiment. The steps illustrated in FIG. 8 may be performed by an apparatus such as, or comprised in, a network element of a wireless communication network. The network element may comprise, for example, a base station, a CU, a DU, an OAM function, or a DSf placed externally from the RAN or inside a RAN entity.

Referring to FIG. 8, a configuration for logging and/or reporting measurement data according to one or more criteria is transmitted 801. The message may be transmitted, for example, to another network element (e.g., a base station or CU), which may forward the configuration to one or more terminal devices. Alternatively, the message may be transmitted directly to the one or more terminal devices. A set of measurement data corresponding with the one or more criteria is received 802. The set of measurement data may be received, for example, from the other network element or from the one or more terminal devices. Herein the measurement data may refer to radio measurement data associated with one or more radio signals received by the one or more terminal devices.

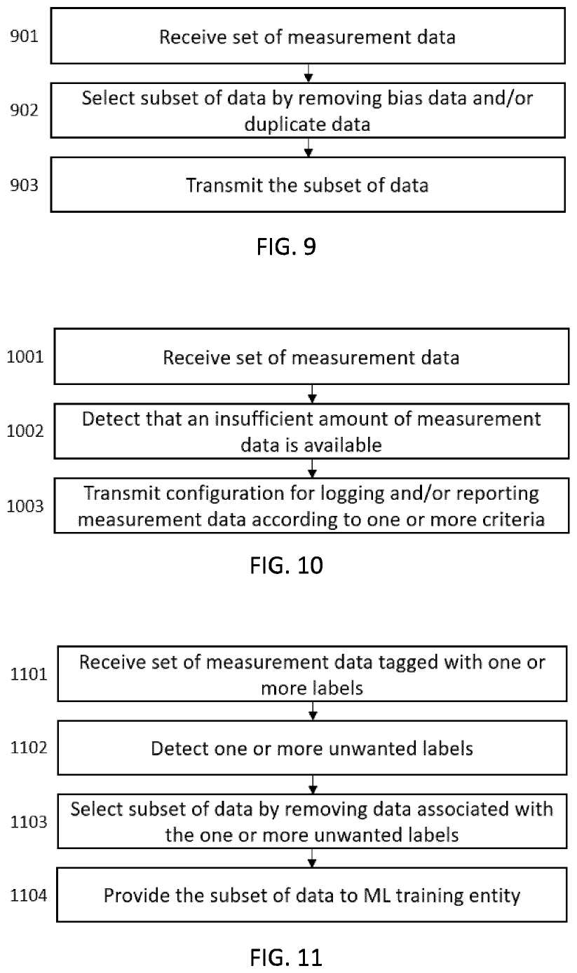

FIG. 9 illustrates a flow chart according to an exemplary embodiment, wherein bias data and/or duplicate data is removed for a data consumer (e.g., an ML training entity). The steps illustrated in FIG. 9 may be performed by an apparatus such as, or comprised in, a network element of a wireless communication network. The network element may comprise, for example, a base station, a CU, a DU, an OAM function, or a DSf.

Referring to FIG. 9, a set of measurement data is received 901. A subset of data is selected 902 from the measurement data by removing at least bias data and/or duplicate data from the measurement data. The subset of data is transmitted 903 for example to a data consumer, such as an ML training entity.

The DSf may also help at the gNB or CU side to detect error situations. For example, the DSf may be used to discover null or missing training data. In this case, the DSf may detect that no measurement data or an insufficient amount of measurement data is reported regarding a specific dataset or label, or for a specific time interval or area. This can be done, for example, by letting the gNB or CU compare the received tagged measurement data in order to compare the amount of measurements fulfilling the one or more criteria against the amount of measurements not fulfilling the one or more criteria. In other words, the insufficient amount of data may be detected based on a ratio of the amount of measurement data fulfilling the one or more criteria compared to the amount of measurement data not fulfilling the one or more criteria (e.g., if the ratio is lower than a threshold).

FIG. 10 illustrates a flow chart according to an exemplary embodiment, wherein missing data is discovered. The steps illustrated in FIG. 10 may be performed by an apparatus such as, or comprised in, a network element of a wireless communication network. The network element may comprise, for example, a base station, a CU, a DU, an OAM function, or a DSf.

Referring to FIG. 10, the network element receives 1001 a set of measurement data. The network element detects 1002 that the received set of measurement data comprises an insufficient amount of measurement data, or no measurement data, for a specific time interval or a specific area. Based on the detection outcome, the network element transmits 1003 a configuration for logging and/or reporting measurement data according to one or more criteria. The one or more criteria may comprise at least the specific time interval or the specific area, for which there is an insufficient amount of measurement data. The configuration may be transmitted to one or more UEs or to another network element (e.g., a gNB or CU).

Alternatively or additionally, an indication indicating that an insufficient amount of measurement data was detected for the specific time interval or the specific area may be transmitted to the one or more UEs or to the other network element.

The DSf may also be used to detect unwanted labels and/or unwanted data. Tagging according to the one or more criteria may further act as data labeling and may therefore detect if the current labeling comprises unwanted labels. This can be done for instance if the measurement data should have a specific distribution, but the distribution of the tagged measurement data is different than the expected distribution. This could also provide already labelled data, thus performing an otherwise time-consuming data preparation task in advance.

FIG. 11 illustrates a flow chart according to an exemplary embodiment, wherein an incorrect label is detected. The steps illustrated in FIG. 11 may be performed by an apparatus such as, or comprised in, a network element of a wireless communication network. The network element may comprise, for example, a base station, a CU, a DU, an OAM function, or a DSf.

Referring to FIG. 11, a set of measurement data tagged with one or more labels is received 1101. One or more unwanted labels are detected 1102 by comparing a distribution of the tagged measurement data in the received set of measurement data to an expected distribution. A subset of data is selected 1103 from the received set of measurement data by removing the measurement data associated with the one or more unwanted labels from the received set of measurement data. The selected subset of data may be provided 1104 to an ML training entity. The data associated with the one or more unwanted labels may possibly be used for network monitoring purposes, but it may not be used for training of an ML algorithm or model. The one or more unwanted labels refer to labels that were not requested, but were received anyway.

The steps and/or blocks described above by means of FIGS. 3-11 are in no absolute chronological order, and some of them may be performed simultaneously or in an order differing from the described one. Other steps and/or blocks may also be executed between them or within them.

A technical advantage provided by some exemplary embodiments is that they may reduce the amount of measurement data collected by the network (i.e., reduce the amount of signaling between the UE and the network). Additionally, some exemplary embodiments may solve potential bias or gap or any other type of error that affects a training dataset, which may be specific to a given ML model and/or use case. The training dataset can be prepared for ML training by removing the biases and gaps. This kind of data collection may leverage the DSf, which performs an analysis of the data to enforce that the dataset is balanced, that the input data has the expected distribution (by comparing training data with inference or based on a recommendation received by the data consumer), and that the dataset captures the features needed for optimizing the task, thus preventing potential training errors.

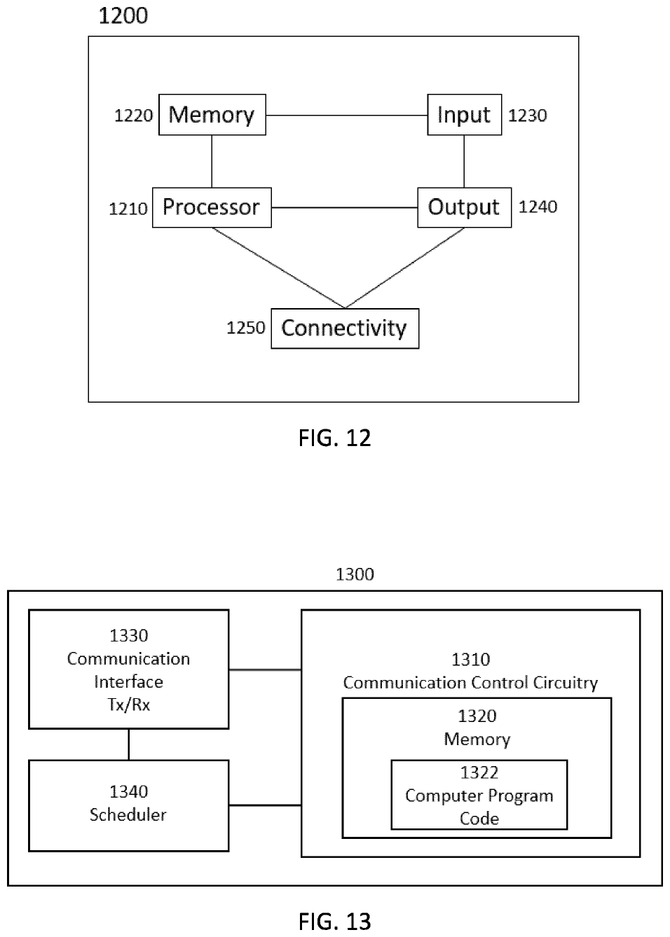

FIG. 12 illustrates an apparatus 1200, which may be an apparatus such as, or comprised in, a terminal device, according to an exemplary embodiment. The terminal device may also be referred to as a UE or user equipment or second apparatus herein. The apparatus 1200 comprises a processor 1210. The processor 1210 interprets computer program instructions and processes data. The processor 1210 may comprise one or more programmable processors. The processor 1210 may comprise programmable hardware with embedded firmware and may, alternatively or additionally, comprise one or more application-specific integrated circuits (ASICs).

The processor 1210 is coupled to a memory 1220. The processor is configured to read and write data to and from the memory 1220. The memory 1220 may comprise one or more memory units. The memory units may be volatile or non-volatile. It is to be noted that in some exemplary embodiments there may be one or more units of non-volatile memory and one or more units of volatile memory or, alternatively, one or more units of non-volatile memory, or, alternatively, one or more units of volatile memory. Volatile memory may be for example random-access memory (RAM), dynamic random-access memory (DRAM) or synchronous dynamic random-access memory (SDRAM). Non-volatile memory may be for example read-only memory (ROM), programmable read-only memory (PROM), electronically erasable programmable read-only memory (EEPROM), flash memory, optical storage or magnetic storage. In general, memories may be referred to as non-transitory computer readable media. The memory 1220 stores computer readable instructions that are executed by the processor 1210. For example, non-volatile memory stores the computer readable instructions and the processor 1210 executes the instructions using volatile memory for temporary storage of data and/or instructions.

The computer readable instructions may have been pre-stored to the memory 1220 or, alternatively or additionally, they may be received, by the apparatus, via an electromagnetic carrier signal and/or may be copied from a physical entity such as a computer program product. Execution of the computer readable instructions causes the apparatus 1200 to perform one or more of the functionalities described above.

In the context of this document, a “memory” or “computer-readable media” or “computer-readable medium” may be any non-transitory media or medium or means that can contain, store, communicate, propagate or transport the instructions for use by or in connection with an instruction execution system, apparatus, or device, such as a computer.

The apparatus 1200 may further comprise, or be connected to, an input unit 1230. The input unit 1230 may comprise one or more interfaces for receiving input. The one or more interfaces may comprise for example one or more temperature, motion and/or orientation sensors, one or more cameras, one or more accelerometers, one or more microphones, one or more buttons and/or one or more touch detection units. Further, the input unit 1230 may comprise an interface to which external devices may connect to.

The apparatus 1200 may also comprise an output unit 1240. The output unit may comprise or be connected to one or more displays capable of rendering visual content, such as a light emitting diode (LED) display, a liquid crystal display (LCD) and/or a liquid crystal on silicon (LCoS) display. The output unit 1240 may further comprise one or more audio outputs. The one or more audio outputs may be for example loudspeakers.

The apparatus 1200 further comprises a connectivity unit 1250. The connectivity unit 1250 enables wireless connectivity to one or more external devices. The connectivity unit 1250 comprises at least one transmitter and at least one receiver that may be integrated to the apparatus 1200 or that the apparatus 1200 may be connected to. The at least one transmitter comprises at least one transmission antenna, and the at least one receiver comprises at least one receiving antenna. The connectivity unit 1250 may comprise an integrated circuit or a set of integrated circuits that provide the wireless communication capability for the apparatus 1200. Alternatively, the wireless connectivity may be a hardwired application-specific integrated circuit (ASIC). The connectivity unit 1250 may comprise one or more components such as a power amplifier, digital front end (DFE), analog-to-digital converter (ADC), digital-to-analog converter (DAC), frequency converter, (de)modulator, and/or encoder/decoder circuitries, controlled by the corresponding controlling units.

It is to be noted that the apparatus 1200 may further comprise various components not illustrated in FIG. 12. The various components may be hardware components and/or software components.

The apparatus 1300 of FIG. 13 illustrates an exemplary embodiment of an apparatus such as, or comprised in, a network element of a wireless communication network. The network element may also be referred to, for example, as a first apparatus, a network node, a RAN node, a NodeB, an LTE evolved NodeB (eNB), a gNB, an NR base station, a 5G base station, an access node, an access point (AP), a distributed unit (DU), a central unit (CU), a baseband unit (BBU), a radio unit (RU), a radio head, a remote radio head (RRH), a transmission and reception point (TRP), an operations, administration and maintenance (OAM) function, or a data selection functionality (DSf). The apparatus may comprise, for example, a circuitry or a chipset applicable to realizing some of the described exemplary embodiments. The apparatus 1300 may be an electronic device comprising one or more electronic circuitries. The apparatus 1300 may comprise a communication control circuitry 1310 such as at least one processor, and at least one memory 1320 including a computer program code (software) 1322 wherein the at least one memory and the computer program code (software) 1322 are configured, with the at least one processor, to cause the apparatus 1300 to carry out some of the exemplary embodiments described above.

The processor is coupled to the memory 1320. The processor is configured to read and write data to and from the memory 1320. The memory 1320 may comprise one or more memory units. The memory units may be volatile or non-volatile. It is to be noted that in some exemplary embodiments there may be one or more units of non-volatile memory and one or more units of volatile memory or, alternatively, one or more units of non-volatile memory, or, alternatively, one or more units of volatile memory. Volatile memory may be for example random-access memory (RAM), dynamic random-access memory (DRAM) or synchronous dynamic random-access memory (SDRAM). Non-volatile memory may be for example read-only memory (ROM), programmable read-only memory (PROM), electronically erasable programmable read-only memory (EEPROM), flash memory, optical storage or magnetic storage. In general, memories may be referred to as non-transitory computer readable media. The memory 1320 stores computer readable instructions that are executed by the processor. For example, non-volatile memory stores the computer readable instructions and the processor executes the instructions using volatile memory for temporary storage of data and/or instructions.

The computer readable instructions may have been pre-stored to the memory 1320 or, alternatively or additionally, they may be received, by the apparatus, via an electromagnetic carrier signal and/or may be copied from a physical entity such as a computer program product. Execution of the computer readable instructions causes the apparatus 1300 to perform one or more of the functionalities described above.

The memory 1320 may be implemented using any suitable data storage technology, such as semiconductor-based memory devices, flash memory, magnetic memory devices and systems, optical memory devices and systems, fixed memory and/or removable memory. The memory may comprise a configuration database for storing configuration data. For example, the configuration database may store a current neighbour cell list, and, in some exemplary embodiments, structures of the frames used in the detected neighbour cells.

The apparatus 1300 may further comprise a communication interface 1330 comprising hardware and/or software for realizing communication connectivity according to one or more communication protocols. The communication interface 1330 comprises at least one transmitter (Tx) and at least one receiver (Rx) that may be integrated to the apparatus 1300 or that the apparatus 1300 may be connected to. The communication interface 1330 provides the apparatus with radio communication capabilities to communicate in the cellular communication system. The communication interface may, for example, provide a radio interface to terminal devices. The apparatus 1300 may further comprise another interface towards a core network such as the network coordinator apparatus and/or to the access nodes of the cellular communication system. The apparatus 1300 may further comprise a scheduler 1340 that is configured to allocate resources.

As used in this application, the term “circuitry” may refer to one or more or all of the following: a) hardware-only circuit implementations (such as implementations in only analog and/or digital circuitry); and b) combinations of hardware circuits and software, such as (as applicable): i) a combination of analog and/or digital hardware circuit(s) with software/firmware and ii) any portions of hardware processor(s) with software (including digital signal processor(s)), software, and memory(ies) that work together to cause an apparatus, such as a mobile phone, to perform various functions); and c) hardware circuit(s) and/or processor(s), such as a microprocessor(s) or a portion of a microprocessor(s), that requires software (for example firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The techniques and methods described herein may be implemented by various means. For example, these techniques may be implemented in hardware (one or more devices), firmware (one or more devices), software (one or more modules), or combinations thereof. For a hardware implementation, the apparatus(es) of exemplary embodiments may be implemented within one or more application-specific integrated circuits (ASICs), digital signal processors (DSPs), digital signal processing devices (DSPDs), programmable logic devices (PLDs), field programmable gate arrays (FPGAs), graphics processing units (GPUs), processors, controllers, micro-controllers, microprocessors, other electronic units designed to perform the functions described herein, or a combination thereof. For firmware or software, the implementation can be carried out through modules of at least one chipset (for example procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

It will be obvious to a person skilled in the art that, as technology advances, the inventive concept may be implemented in various ways. The embodiments are not limited to the exemplary embodiments described above, but may vary within the scope of the claims. Therefore, all words and expressions should be interpreted broadly, and they are intended to illustrate, not to restrict, the exemplary embodiments.

### List of Abbreviations

4G: fourth generation
5G: fifth generation
ADC: analog-to-digital converter
AI: artificial intelligence
AP: access point
ASIC: application-specific integrated circuit
BBU: baseband unit
CN: core network
C-plane: control plane
CPS: cyber-physical system
CSI: channel state information
CSSP: customer-specific standard product
CU: central unit
CU-CP: central unit control plane
CU-UP: central unit user plane
DAC: digital-to-analog converter
DFE: digital front end
DRAM: dynamic random-access memory
DSf: data selection functionality
DSP: digital signal processor
DSPD: digital signal processing device
DU: distributed unit
EEPROM: electronically erasable programmable read-only memory
f: function
FPGA: field programmable gate array
GEO: geostationary earth orbit
gNB: next generation nodeB/5G base station
GNSS: global navigation satellite system
GPS: global positioning system
GPU: graphics processing unit
HNB-GW: home node B gateway
IAB: integrated access and backhaul
ID: identifier
IMEI: international mobile equipment identity
IMS: internet protocol multimedia subsystem
IMS: IP multimedia subsystem
IMSI: international mobile subscriber identity
IoT: internet of things
IP: internet protocol
L1: Layer 1
L2: Layer 2
L3: Layer 3
LCD: liquid crystal display
LCoS: liquid crystal on silicon
LED: light emitting diode
LEO: low earth orbit
LTE: long term evolution
LTE-A: long term evolution advanced
M2M: machine-to-machine
MAC: medium access control
MANET: mobile ad-hod network
MBS: multicast and broadcast services
MDAF: management data analytics function
MDT: minimization of drive testing
MEC: multi-access edge computing
MIMO: multiple input and multiple output
ML: machine learning
MME: mobility management entity
mMTC: massive machine-type communications
MT: mobile termination
MTSI: multimedia telephony service for IMS
NFV: network function virtualization
NGC: next generation core
NR: new radio
NWDAF: network data analytics function
OAM: operations, administration and maintenance
PCS: personal communications services
PDA: personal digital assistant
PDCP: packet data convergence protocol
P-GW: packet data network gateway
PHY: physical
PHY: physical
PLD: programmable logic device
PLMN: public land mobile network
PROM: programmable read-only memory
QoS: quality of service
RAM: random-access memory
RAN: radio access network
RAP: radio access point
RAT: radio access technology
RF: radio frequency
RI: radio interface
RIC: RAN intelligent controller
RLC: radio link control
ROM: read-only memory
RRC: radio resource control
RRH: remote radio head
RSRP: reference signal received power
RSRQ: reference signal radio quality
RU: radio unit
RX: receiver
SDAP: service data adaptation protocol
SDN: software defined networking
SDRAM: synchronous dynamic random-access memory
S-GW: serving gateway
SIM: subscriber identification module
SINR: signal-to-interference-plus-noise ratio
S-NSSAI: single network slice selection assistance information
SoC: system-on-a-chip
sst: slice service type
sst-sd: slice service type slice differentiator
TCE: trace collection entity
TRP: transmission and reception point
TRX: transceiver
TX: transmitter
UE: user equipment/terminal device
UMTS: universal mobile telecommunications system
U-plane: user plane
UTRAN: UMTS radio access network
UWB: ultra-wideband
vCU: virtualized central unit
vDU: virtualized distributed unit
VR: virtual reality
WCDMA: wideband code division multiple access
WiMAX: worldwide interoperability for microwave access
WLAN: wireless local area network

1.-18. (canceled)

19. An apparatus comprising at least one processor, and at least one memory including computer program code, wherein the at least one memory and the computer program code are configured, with the at least one processor, to cause the apparatus to:
transmit a configuration for logging and/or reporting at least tagged measurement data according to one or more criteria;
receive a set of measurement data corresponding with the one or more criteria, wherein the set of measurement data comprises at least the tagged measurement data;
detect one or more unwanted labels in the set of measurement data;
select a subset of measurement data from the received set of measurement data by removing data associated with the one or more unwanted labels; and
provide the subset of measurement data to a machine leaning training entity.

20. The apparatus according to claim 19, wherein the configuration indicates to tag a first set of measurement data that fulfils the one or more criteria with a first label, wherein the first label indicates that the one or more criteria are fulfilled;
wherein the received set of measurement data comprises at least the first set of measurement data tagged with the first label.

21. The apparatus according to claim 19, wherein the configuration indicates to tag a second set of measurement data that does not fulfil the one or more criteria with a second label, wherein the second label indicates that the one or more criteria are not fulfilled;
wherein the received set of measurement data comprises at least the second set of measurement data tagged with the second label.

22. The apparatus according to claim 19, wherein the configuration indicates to log and/or report the tagged measurement data and untagged measurement data;
wherein the received set of measurement data comprises the tagged measurement data and the untagged measurement data.

23. The apparatus according to claim 19, wherein the configuration indicates to log and/or report the tagged measurement data and to discard untagged measurement data;
wherein the received set of measurement data comprises the tagged measurement data.

24. The apparatus according to claim 19, wherein the configuration indicates to report the tagged measurement data with a different periodicity and/or with a different signaling radio bearer than untagged measurement data.

25. The apparatus according to claim 19, wherein the one or more unwanted labels are detected by comparing a distribution of the tagged measurement data to an expected distribution.

26. The apparatus according to claim 19, wherein the apparatus is further caused to:
select a subset of measurement data from the received set of measurement data by removing at least bias data and/or duplicate data from the measurement data; and
transmit the subset of measurement data.

27. The apparatus according to claim 19, wherein the one or more criteria comprise at least one of: a specific network slice, a specific group of network slices, a specific sequence of network slices, and/or a specific service.

28. The apparatus according to claim 19, wherein the configuration indicates to limit the logging and/or the reporting to a group of terminal devices that fulfil the one or more criteria based at least partly on at least one of: a network slice associated with the group of terminal devices, a group of network slices associated with the group of terminal devices, and/or one or more services supported by the group of terminal devices.

29. The apparatus according to claim 19, wherein the configuration indicates to log and/or report the measurement data, if a difference between two consecutive signal level values is larger than a first threshold value.

30. The apparatus according to claim 19, wherein the configuration indicates to log and/or report the measurement data, if a measured signal level value exceeds a second threshold value.

31. The apparatus according to claim 19, wherein the configuration indicates to log and/or report the measurement data, if a decrease in performance is larger than a third threshold value.

32. The apparatus according to claim 19, wherein the apparatus is further caused to:
detect an insufficient amount of measurement data for a specific time interval or a specific area;
wherein the configuration is transmitted in response to detecting the insufficient amount of measurement data, and wherein the one or more criteria comprise at least the specific time interval or the specific area associated with the insufficient amount of measurement data.

33. A system comprising at least a first apparatus and a second apparatus;
wherein the first apparatus is configured to:
transmit, to the second apparatus, a configuration for logging and/or reporting at least tagged measurement data according to one or more criteria;
receive, from the second apparatus, a set of measurement data corresponding with the one or more criteria, wherein the set of measurement data comprises at least the tagged measurement data;
detect one or more unwanted labels in the set of measurement data;
select a subset of measurement data from the received set of measurement data by removing data associated with the one or more unwanted labels; and
provide the subset of measurement data to a machine leaning training entity;
wherein the second apparatus is configured to:
receive the configuration from the first apparatus;
obtain the set of measurement data corresponding with the one or more criteria; and
transmit, to the first apparatus, the set of measurement data corresponding with the one or more criteria.

34. An apparatus comprising means for:
transmitting a configuration for logging and/or reporting at least tagged measurement data according to one or more criteria;
receiving a set of measurement data corresponding with the one or more criteria, wherein the set of measurement data comprises at least the tagged measurement data;
detecting one or more unwanted labels in the set of measurement data;
selecting a subset of measurement data from the received set of measurement data by removing data associated with the one or more unwanted labels; and
providing the subset of measurement data to a machine leaning training entity.
